(19) United States
(12) Patent Application Publication
(10) Pub. No.: US 2025/0378209 A1
(43) Pub. Date: Dec. 11, 2025

(54) Algorithm for Computer-Aided Designing and Modeling of Patient-Specific Implant

(71) Applicant: The University of Hong Kong, Hong Kong (CN)

(72) Inventors: Yuxiong SU, Hong Kong (CN); Jingya PU, Hong Kong (CN); Ankit NAYAK, Hong Kong (CN)

(73) Assignee: The University of Hong Kong, Hong Kong (CN)

(21) Appl. No.: 19/232,672

(22) Filed: Jun. 9, 2025

Related U.S. Application Data
(60) Provisional application No. 63/658,675, filed on Jun. 11, 2024.

(51) Int. Cl. G06F 30/10; G06F 111/16; G06F 113/10

(52) U.S. Cl. CPC G06F 30/10; G06F 2111/16; G06F 2113/10

(57) ABSTRACT

A method for forming a patient-specific implant (PSI) part for application to a resected body part to form a reconstructed part involves utilizing a StereoLithography (STL) model of the reconstructed part with trace lines and the location of screw holes for screws to fasten the PSI to the resected body part in forming the reconstructed part. The trace lines are processed using cubic-spline data interpolation and smoothing, followed by the generation and transformation of rectangles to create a skeleton that forms the implant's surface model. The screw holes are added to the model after the trace lines are processed. Next, the model is converted into an STL file, which is made available for forming implant material into the PSI.

### CROSS-REFERENCE TO RELATED PATENT APPLICATIONS

This application claims the benefit of priority under 35 U.S.C. Section 119(e) of U.S. Application No. 63/658,675 filed Jun. 11, 2024, which is incorporated herein by reference in its entirety.

### FIELD OF THE INVENTION

The present invention relates to Computer-Aided Design of patient specific implants, and more particularly to the design of jaw implants.

### BACKGROUND OF THE INVENTION

The skeleton of human jaws plays a crucial role in the daily life of people in maintaining the airway for breathing, facial esthetics, mastication, and language articulation. After resection surgeries for pathology involving the upper and lower jaws, it is important to reconstruct the missing structures for patients to resume normal functions [1]. Vascular free tissue transfer from other parts of the body for reconstruction of jaw defects has gained popularity over the years due to its predictable outcome and minimum donor site morbidity [2].

The commonly used donor sites include fibula, iliac crest, and scapula. However, they typically have different shapes than human jaws. Meticulous segmentation and trimming are necessary to reproduce the shape of human jaws with the bone harvested [3]. This process is time-consuming and technique sensitive. This has pushed the development of computer-assisted surgery (CAS), which has brought about a groundbreaking transformation in jaw resection and reconstruction in recent years. The process is disclosed and verified in previous publications of the present inventors [4, 5]. Virtual surgical planning (VSP) of the resection and reconstruction is performed virtually on the computer before the surgery by the surgeons and the engineers. The VSP is transferred to the operating room by the application of 3D-printed patient-specific surgical guides and plates.

For the case illustrated in FIGS. 1A-1H a 72-year-old male patient presented with squamous cell carcinoma of the left lower gingiva. He had undergone computer-assisted surgery for mandible resection and reconstruction with a fibula-free flap. FIG. 1A shows a virtual surgical plan of the resection guides of the mandible. In FIG. 1B 3D-printed patient-specific guides are shown fixed to the mandible skeleton during the surgery. FIG. 1C shows the resected tumor specimen. A virtual surgical plan of the fibula harvest and segmentation guide is shown in FIG. 1D and a 3D-printed fibula guide fixed to the fibula bone during the surgery is shown in FIG. 1E. Design of the patient-specific plate is shown in FIG. 1F while FIG. 1G shows the 3D-printed patient-specific plate fixed to the fibula segments to reproduce the shape of mandible. In FIG. 1H fibula segments are shown with the plate transferred intraorally to repair the mandible defect. This CAS has greatly facilitated surgeries by making the process safer, more predictable, efficient, and accurate [6, 7]. It has become the new standard of care in many major centers in the world.

Despite the numerous advantages of CAS, concerns regarding the time spent during the VSP have arisen over the years. Reliable planning requires clinical judgement from surgeons. While the design of the patient-specific guides and plates is usually performed by the engineers, specific computer-aided design (CAD) skills are required, and the process is often time-consuming. Communication between surgeons and engineers often involves multiple discussions [8-10], which adds to the burden on both parties and are prone to miscommunication and unfavorable clinical outcomes.

In particular, current patient-specific implant (PSI) design practices utilize CAD tools to model the plate through manual command execution, which can be time-consuming when manipulating primitive 3D geometric shapes into implants using Boolean operations [11, 12].

US Patent Application Publication: US20230380877A1 discloses methods, devices, and the manufacture of the devices for musculoskeletal reconstructive surgery. It discusses steps that are carried out manually. It does not claim any automatic algorithm for implant design. The patent application presents engineered NiTi Parts with Defined Porosity. The article Du et al., “A Systematic Approach for Making 3D-Printed Patient-Specific Implants for Craniomaxillofacial Reconstruction,” https://doi.org/10.1016/j.eng.2020.02.019 presents a design module developed on Solidworks® (Dassault Systemes Global Services Pvt. Ltd., France). The module is not capable of delivering a ready-to-print design. It needs additional iterations, and it does not change the shape of the implant to manage the stress flow.

Many surgeons face challenges related to the time and engineering skills needed for planning and designing patient-specific plates and guides. Thus, an ability to tackle these difficulties associated with the creation of PSI would be of great benefit in the field.

### SUMMARY OF THE INVENTION

To tackle the difficulties associated with the creation of patient-specific implants (PSI), the present invention proposes a groundbreaking algorithm that streamlines the traditionally intricate and time-consuming CAD process. In particular, the invention solves the problem of the challenges of the complex and time-consuming process involved in designing PSI for jaw resection and reconstruction using computer-assisted surgery. These challenges include the need for advanced engineering skills and extensive time spent on planning and designing customized plates and guides.

The problem is solved by introducing a novel algorithm that streamlines the CAD process, thus meeting a long-felt need for a more efficient and accessible method of creating patient-specific implants. The algorithm simplifies the design process by automating several steps, such as processing trace lines, generating and transforming rectangles, and incorporating screw holes. Additionally, it enhances the strength of the implants by modifying stress concentration areas.

This innovative algorithm requires a StereoLithography (STL) model of the reconstructed part (e.g., the reconstructed mandible), trace lines, and the location of screw holes as input. The algorithm then processes the trace lines using cubic-spline data interpolation and smoothing techniques. Subsequently, it generates and transforms rectangles to create a skeleton that forms the implant's surface model. Once the screw holes are incorporated, the model is converted into an STL file, a format commonly used for patient specific implants.

The method, which relates to creating customized parts for connecting PSI with streamlined CAD process, requires the user to input the 3D implant model from a CT scan as well as the location of the reconstructed plates and the screw holes. This method creates the STL model of the reconstructed part by creating trace lines according to the screw holes, which are input by the user, for screws to fasten the implant to the reconstructed part. The trace lines are processed using cubic spline data interpolation and smoothing followed by the generation of rectangles to create a skeleton of the plates. The force balance of each portion of each of the plates is calculated when creating the plates with implants. Thus, the algorithm involves converting the 3D model into an STL file by automating the plate creation process which only requires minimal input from the surgeons.

A unique aspect of this invention is the algorithm's ability to modify stress concentration areas, thereby enhancing the implant's strength in withstanding the load. This simplifies the CAD process for patient-specific implants and has the potential to greatly benefit surgeons and patients alike.

Moreover, the developed algorithm allows for alterations (if required) to the design in a matter of minutes. It adjusts the shape of the implant to manage stress concentration, ensuring the longevity and durability of the implant.

Ultimately, this invention helps to improve the efficiency and effectiveness of surgical planning, reduces the time and expertise required for designing patient-specific implants, and has the potential to lead to better outcomes for patients undergoing jaw resection and reconstruction procedures.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects and advantages of the present invention will become more apparent when considered in connection with the following detailed description and appended drawings in which like designations denote like elements in the various views, and wherein:

FIG. 1A is a schematic diagram of the left lower gingiva of a patient with squamous cell carcinoma after CAS for mandible resection and reconstruction with a fibula-free flap showing a virtual surgical plan of the resection guides of the mandible, FIG. 1B is an image of 3D-printed patient-specific guides fixed to the mandible skeleton during the surgery, FIG. 1C is an image of a resected tumor specimen from the patient, FIG. 1D is a schematic of a virtual surgical plan of the fibula harvest and segmentation guide, FIG. 1E is an image of a 3D-printed fibula guide fixed to the fibula bone during the surgery, FIG. 1F is a diagram of the design of the patient-specific plate for the patient, FIG. 1G is an image of a 3D-printed patient-specific plate fixed to the fibula segments in order to reproduce the shape of mandible and FIG. 1H is an image showing fibula segments with the plate transferred intraorally to repair the mandible defect;

FIG. 2 is a solid model of the reconstructed mandible;

FIG. 3A show manually selected data points on the reconstructed mandible and FIG. 3B shows a curve generated from cubic spline data interpolation of the points;

FIG. 4 is a graph showing the smoothing of the curve of FIG. 3B;

FIG. 5A shows a rectangle representing the cross-sectional area of the surgical plate and FIG. 5B shows a geometrical model (surface model of the surgical plate) generated by sweeping the rectangle along the sweep path and guide curve;

FIG. 6 is a graph of rectangles having variable height at their ends to generate a circular disc-shaped structure;

FIG. 7A shows intersecting rectangles along the sweep path and FIG. 7B is a top view of the rectangles showing intersection in the block of corners (−9, −105) and (−8, −104);

FIG. 8A is a graph of a surface model of the plate without a hole, FIG. 8B is a diagram showing a surface model of the hole with different parameters, FIG. 8C shows a surface model of different holes aligned with the hole axis and position, zoomed (insert) in areas of (7,73) and (18,80) showing the different facets and their normal pointing in the outward directions and FIG. 8D is an STL model of the surgical plate, zoomed (insert) in areas of (7,73) and (18,80) showing the countersunk hole for the screw fastener;

FIG. 9 is a model of muscle force direction and value including Superficial Masseter (SMR), Deep Masseter (DMR), Medial Pterygoid (MPR), Anterior Temporalis (ATR), Middle Temporalis (MTR), Posterior Temporalis (PTR), Inferior Lateral Pterygoid (ILPR) for the right side of the mandible and Medial Pterygoid (MPL), Anterior Temporalis (ATL), Middle Temporalis (MTL), Posterior Temporalis (PTL), Inferior Lateral Pterygoid (ILPL) for the left side of the mandible, and RMCL showing the fixed support in the normal direction of the molar teeth to simulate right molar clenching;

FIG. 10 shows the generated STL file from the computer program, and a zoomed image (insert) of a hole showing adaptive tessellation near the hole boundary to minimize the volumetric error;

FIG. 11A is an equivalent (von-Mises) stress graph for the reconstructed mandible assembly, FIG. 11B is an equivalent stress distribution in PSI with the zoomed (insert) image showing the high stress concentration zone for plate and FIG. 11C is an equivalent stress distribution in different screws with the zoom (insert) image showing the screw which faces the maximum stress; and

FIG. 12A is an equivalent elastic strain graph for the reconstructed mandible assembly, FIG. 12B is an equivalent elastic strain distribution in PSI with the zoomed (insert) image showing the high-strain rate zone for the plate and FIG. 12C is an equivalent elastic strain distribution in different screws with the zoom (insert) image showing the screw which faces the maximum strain.

### DETAILED DESCRIPTION OF THE INVENTION

The present invention involves a novel algorithm for designing patient-specific implants (PSI) that simplifies the traditionally complex and time-consuming Computer-Aided Design (CAD) process. The algorithm requires a StereoLithography (STL) model of the reconstructed part, trace lines and the location of screw holes. The trace lines are processed using cubic-spline data interpolation and smoothing, followed by the generation and transformation of rectangles to create a skeleton that forms the implant's surface model. Screw holes are added, and the model is converted into an STL file.

Finite element analysis is performed to assess the functionality of the designed PSI, with the simulation results showing stress levels within acceptable ranges. This innovative algorithm offers a faster, more efficient, and accurate alternative to traditional CAD methods, with the potential to revolutionize the field of patient-specific implant design. Furthermore, the invention demonstrates the utility of a mechanistic model for correlating patient bite force with muscle forces in the literature.

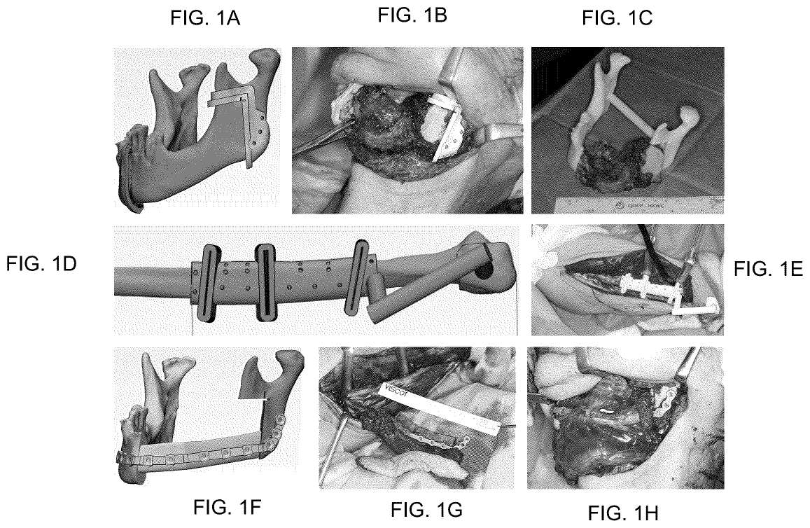

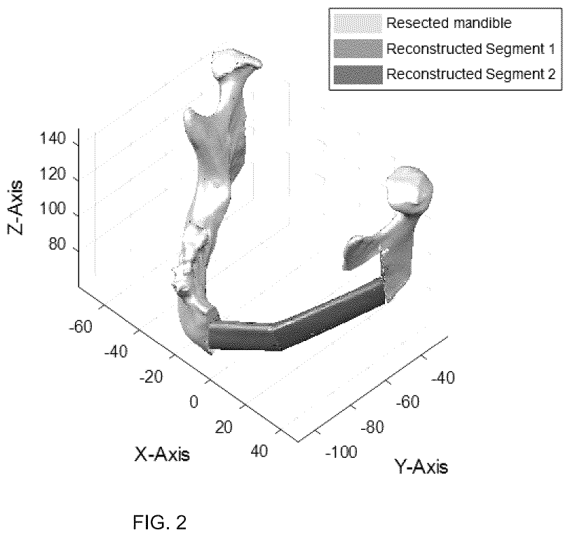

To provide a comprehensive understanding of the proposed algorithm, its application to a reconstructed mandible solid model is illustrated in FIG. 2 in the form of segments 1 and 2. This model is generated using STL files, where the sectioned part of the mandible has been replaced by fibula flap segments, denoted by yellow and green colors in FIG. 1F and orange and blue in FIG. 2. Initially, the STL file containing the reconstructed bone is imported into a custom MATLAB program. Subsequently, the program processes the 3D information of the mandible and represents it as a triangulated model, comprising point cloud data and a connectivity matrix.

The point cloud data is represented by an n×3 matrix, where ‘n’ denotes the number of points in the point cloud. The three columns of the matrix correspond to the x, y, and z coordinates of each point in the 3D space.

On the other hand, the connectivity matrix has dimensions of m×3, where ‘m’ signifies the number of triangles needed to create the CAD model. The three different arrays in the matrix represent the connectivity of the points in such a way that if three points of the connectivity matrix stored in a row are joined, they will form a triangle.

After getting the STL file of the reconstructed model, two 3-dimensional curves on the surface of the STL model of the mandible are attached. A few more points are defined on the STL model that signify the location of the screws to fix the PSI with the reconstructed model. The computer program allows one to visualize the geometry of the mandible and interactively define the points for guide curves and the screw holes.

These points are stored in three different arrays C1, C2 and P1. C1 and C2 are the point data set for two curves and the P1 array contains the coordinates of the screw hole locations. These matrices store n, m and k numbers of points and have n×3, m×3 and k×3 dimensions, respectively.

The selection of points is a manual process carried out by the experienced surgeon. It may be haptic to define many points to attach the curves on the STL. So, to increase the order of automation a cubic-spline data interpolation is used to calculate the intermediate points between each pair of manually selected points and to fit a spline curve accordingly. This reduces the necessity to define many points in order to attach the curve.

Cubic spline interpolation is a technique often used in research to estimate new data points within a given set of known points. This method involves creating an interpolation function, known as a “spline,” which is made up of several cubic polynomial segments. The new data points are then calculated as function values of this spline. Cubic-spline data interpolation interpolates the manually defined data points and inserts a finite number of points between each pair of the data set.

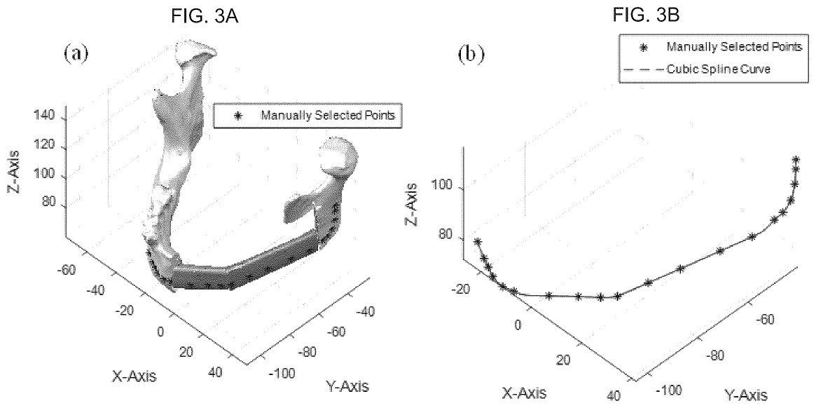

To explain the cubic-spline data interpolation, the data set of only curve 1, which is represented by C1 and has n number of points, is considered. Each pair of two consecutive points is interpolated to calculate the q number of intermediate points. This forms a cubic spline curve as shown in FIG. 3B in comparison to the model shown in FIG. 2 and FIG. 3A.

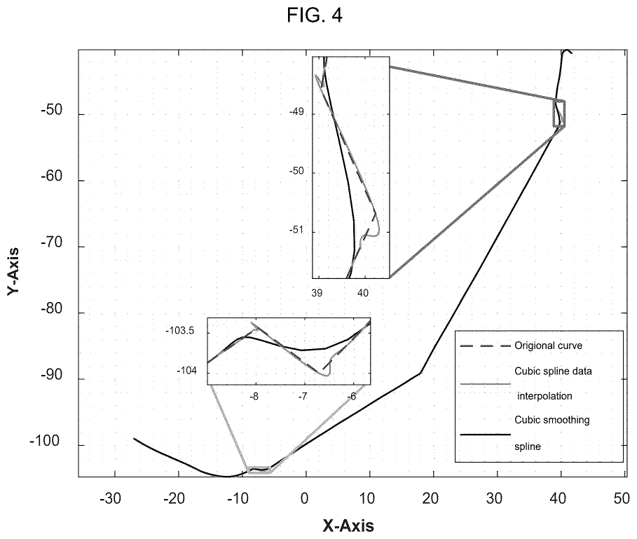

The curve generated by cubic spline interpolation has sharp corners and self-intersections as shown by the green lines in the inserts in FIG. 4, where the red dotted line is the original curve. Three-dimensional geometry generated by sweeping a rectangle representing a cross-sectional area of the surgical plate along the curve may cause stress concentration in the plate or error in STL at these corners. To avoid such sharp points the curve is further smoothened using the cubic smoothing spline algorithm.

This method fits a smooth curve to a given dataset using piecewise cubic polynomials and is implemented in MATLAB using the “csaps” function. The algorithm computes a cubic smoothing spline that balances the proximity of the data points to the curve while preserving the curve's smoothness. This equilibrium is obtained by minimizing a combined metric, which includes a weighted sum of the residual sum of squares and the integral of the squared second derivative of the spline function.

In the present case, spline C1 has n data points, and each data point has x y and z coordinates and is represented as follows—

$$C 1 = [ \begin{matrix}{x}_{1} & {y}_{1} & {z}_{1} \\ {x}_{2} & {y}_{2} & {z}_{2} \\ ⋮ & ⋮ & ⋮ \\ {x}_{n} & {y}_{n} & {z}_{n}\end{matrix} ]$$

For the given set of data, the x y and z coordinates of each point are smoothened against a normalized scale ns=[1, 2, 3, 4 . . . n]. Therefore, the cubic spline smoothing of each column of the C1 matrix is performed against ns, and then the smoothed datasets are combined to form the smooth curve. Consider the smoothing of the first column X=[x₁, x₂, . . . , xₙ] of C1 to explain this process. Points (nsᵢ, xᵢ) for i=1, 2, . . . , n, the cubic smoothing spline S(ns) is defined as the function that minimizes the following objective function:

$$P {\sum }_{i = 1}^{n} {w}_{i} {\vert {x}_{i} - S ( n {s}_{i} ) \vert}^{2} + ( 1 - P ) \int {λ ( n s ) [ {S}^{″} ( n s ) ]}^{2} d n s \qquad ( 1 )$$

Here, P is a smoothing parameter that ranges from 0 to 1. The first term in the objective function represents the residual sum of squares, which quantifies the discrepancy between the data points and the spline function. The second term is the integral of the squared second derivative of the spline function, which measures the smoothness of the curve. When P=1, the algorithm produces a least-squares cubic spline, and when P=0, it results in a variational spline.

In the “csaps” function, the cubic smoothing spline is constructed using a set of piecewise cubic polynomials defined over adjacent intervals of the data points. These polynomials are continuous and have continuous first and second derivatives, ensuring the smoothness of the spline function. See the blue line in FIG. 4. The function takes the input data points (nsᵢ, xᵢ) and the smoothing parameter P as inputs and returns the coefficients of the cubic polynomials that define the smoothing spline X̅=[x̅₁, x̅₂, . . . , x̅ₙ].

Similarly, the smooth spline is calculated for each column of C1 i.e. Y̅=[y̅₁, y̅₂, y̅, y̅n] and Z̅=[z̅₁, z̅₂, . . . , z̅ₙ]. The smoothened spline array of each coordinate then combines to form a n×3 matrix of smoothened 3D curve C̅1̅=[X̅^{T} Y̅^{T} Z̅^{T}].

The second curve C2 is processed and transformed into a new curve C̅2̅. The points stored in C̅2̅ are arranged in a sequence such that the Euclidean distance between the i^{th} points of both curves, C̅1̅ and C̅2̅, is minimized. The smoothed curves can be represented as—

$$\overline{C 1} = [ \begin{matrix}{\overline{x}}_{1} & {\overline{y}}_{1} & {\overline{z}}_{1} \\ {\overline{x}}_{2} & {\overline{y}}_{2} & {\overline{z}}_{2} \\ ⋮ & ⋮ & ⋮ \\ {\overline{x}}_{n} & {\overline{y}}_{n} & {\overline{z}}_{n}\end{matrix} ] and \overline{C 2} = [ \begin{matrix}{\overline{k}}_{1} & {\overline{l}}_{1} & {\overline{m}}_{1} \\ {\overline{k}}_{2} & {\overline{l}}_{2} & {\overline{m}}_{2} \\ ⋮ & ⋮ & ⋮ \\ {\overline{k}}_{n} & {\overline{l}}_{n} & {\overline{m}}_{n}\end{matrix} ]$$

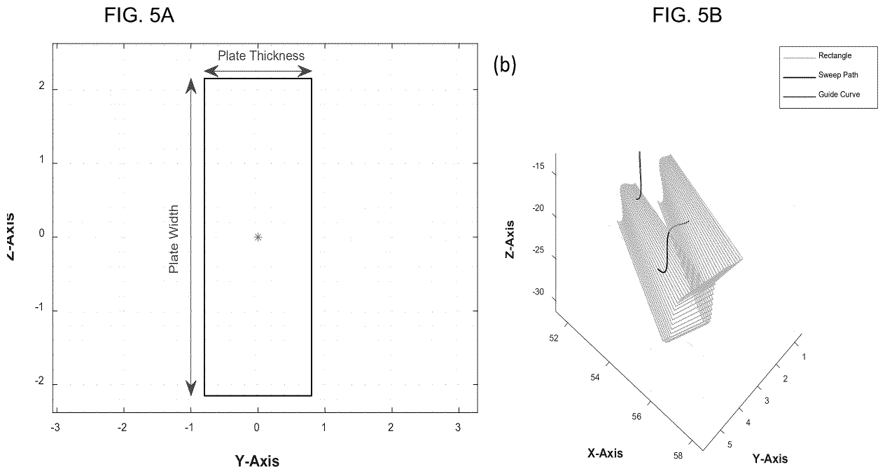

The generated curves C1 and C2 serve as the sweep path and guiding curve, respectively. To minimize transformation-related calculations, the rectangle representing the cross-sectional area of the surgical plate is defined with its geometric center at the origin, as depicted in FIG. 5A. The rectangle is swept along curve C1, and simultaneously, it is tilted about its center to follow the curvature of C2, as illustrated in FIG. 5B. Thus, the model of the surface of the surgical plate is generated using the data points obtained by sweeping the rectangle along curve C1 and the guiding curve C2.

To follow the curvature of the sweep path and the guide curve two conditions are necessary to consider: 1) Maintain the normal to the polygon in the instantaneous direction of the tangent to the path. 2) Rotate the rectangle about its normal so that the longest side of the rectangle becomes parallel to the angulation vector \vec{C̅1̅-C̅2̅}.

From the sweep path and guide curve the instantaneous vector (\hat{v}) and angulation vector (û) are calculated for each point of the sweep path.

$$\vec{{v}_{n}} = {c}_{n} - {c}_{n - 1} \qquad ( 2 )$$

$$( ( \vec{{u}_{n}} = {b}_{n} - {c}_{n}$$

$$where ,$$

$$\begin{matrix}{c}_{n} = [ \begin{matrix}{\overline{x}}_{n} & {\overline{y}}_{n} & {\overline{z}}_{n}\end{matrix} ] \\ {b}_{n} = [ \begin{matrix}{\overline{k}}_{n} & {\overline{l}}_{n} & {\overline{m}}_{n}\end{matrix} ]\end{matrix}$$

$${\hat{v}}_{n} = \frac{{\vec{v}}_{n}}{‖ {\vec{v}}_{n} ‖} \qquad ( 3 )$$

$${\hat{u}}_{n} = \frac{[ {\vec{u}}_{n} ]}{‖ {\vec{u}}_{n} ‖} \qquad ( 4 )$$

In order to align the normal of the rectangle [G] with the instantaneous tangent of the curve, the inclination [αₙ βₙ] of each instantaneous tangent vector (\hat{v}) with respect to the 2-principal axis \hat{x}=[1 0 0] and ŷ=[0 1 0] is calculated, and the rectangle coordinates are transformed by sequentially multiplying them with the rotation matrices R_{z} and R_{y}. R_{z} represents the rotation matrix about the z-axis, while R_{y} represents the rotation matrix about the updated rotational axis A_{y} of the rectangle after rotation about the z-axis.

$$[ G ] [ {R}_{z} ] = [ \begin{matrix}- {g}_{11} sin {α}_{n} & {g}_{11} cos {α}_{n} & {g}_{12} & 1 \\ - {g}_{21} sin {α}_{n} & {g}_{21} cos {α}_{n} & {g}_{22} & 1 \\ - {g}_{31} sin {α}_{n} & {g}_{31} cos {α}_{n} & {g}_{32} & 1 \\ - {g}_{41} sin {α}_{n} & {g}_{41} cos {α}_{n} & {g}_{42} & 1\end{matrix} ] \qquad ( 5 )$$

From this matrix the updated rotational axis A_{y} can be calculated as

$${\vec{A}}_{y} = \frac{1}{2} [ \begin{matrix}- ( {g}_{11} + {g}_{21} - {g}_{31} - {g}_{41} ) sin {α}_{n} \\ ( {g}_{11} + {g}_{21} - {g}_{31} - {g}_{41} ) cos {α}_{n} \\ ( {g}_{12} + {g}_{22} - {g}_{32} - {g}_{42} )\end{matrix} ] \qquad ( 6 )$$

This can be converted into unit vector.

$${\hat{A}}_{y} = \frac{{\vec{A}}_{y}}{‖ {\vec{A}}_{y} ‖} = [ \begin{matrix}{a}_{x} \\ {a}_{y} \\ {a}_{z}\end{matrix} ] \qquad ( 7 )$$

Upon determining the unit vector of rotation using Equation 7, the transformation matrix R_{y} is computed according to Equation 8. Subsequently, this matrix is employed to transform the point cloud of the rectangle, which has been previously calculated via Equation 5. Through this multiplication, the rectangle's normal vector is effectively aligned with the instantaneous tangent of the curve. Moreover, the rectangle points are translated to their corresponding coordinates on the sweep path. The translation matrix, denoted as Tᵣ, is illustrated in Equation 9. This alignment operation is critical for ensuring the accurate representation of the geometric properties of the reconstructed part, which, in turn, is essential for the precise sweeping operation of the rectangle along the sweep path.

$$[ {R}_{y} ] = [ \begin{matrix}cos {β}_{n} + {a}_{x}^{2} ( 1 - cos {β}_{n} ) & {a}_{x} {a}_{y} ( 1 - cos {β}_{n} ) - {a}_{z} sin {β}_{n} & {a}_{x} {a}_{z} ( 1 - cos {β}_{n} ) + {a}_{y} sin {β}_{n} & 0 \\ {a}_{x} {a}_{y} ( 1 - cos {β}_{n} ) + {a}_{z} sin {β}_{n} & cos {β}_{n} + {a}_{y}^{2} ( 1 - cos {β}_{n} ) & {a}_{y} {a}_{z} ( 1 - cos {β}_{n} ) - {a}_{y} sin {β}_{n} & 0 \\ {a}_{z} {a}_{x} ( 1 - cos {β}_{n} ) - {a}_{z} sin {β}_{n} & {a}_{z} {a}_{y} ( 1 - cos {β}_{n} ) - {a}_{x} sin {β}_{n} & cos {β}_{n} + {a}_{z}^{2} ( 1 - cos {β}_{n} & 0 \\ 0 & 0 & 0 & 1\end{matrix} ] \qquad ( 8 )$$

$$[ {T}_{r} ] = [ \begin{matrix}1 & 0 & 0 & 0 \\ 0 & 1 & 0 & 0 \\ 0 & 0 & 1 & 0 \\ {\overline{x}}_{n} & {\overline{y}}_{n} & {\overline{z}}_{n} & 1\end{matrix} ] \qquad ( 9 )$$

$$[ {G}^{′} ] = [ G ] [ {R}_{z} ] [ {R}_{y} ] [ {T}_{r} ] \qquad ( 10 )$$

Matrix G′ represents the transformed coordinates of the rectangle. The first, second, and third columns of the matrix display the x, y, and z coordinates of the four points of the rectangle, respectively. This can be expressed as shown in Equation 11.

$$[ {G}^{′} ] = [ \begin{matrix}{g}_{11}^{′} & {g}_{12}^{′} & {g}_{13}^{′} & 1 \\ {g}_{21}^{′} & {g}_{22}^{′} & {g}_{23}^{′} & 1 \\ {g}_{31}^{′} & {g}_{32}^{′} & {g}_{33}^{′} & 1 \\ {g}_{41}^{′} & {g}_{42}^{′} & {g}_{43}^{′} & 1\end{matrix} ] \qquad ( 11 )$$

From this array the alignment vector wₙ of the rectangle is calculated

$$[ {w}_{n} ] = [ \frac{1}{2} ( {g}_{1}^{′} + {g}_{4}^{′} ) ] - {c}_{n} \qquad ( 11 )$$

Now, the angle γₙ between vectors \vec{w}ₙ and \vec{u}ₙ is computed, followed by the rotation of the rectangle by γₙ with respect to its normal vector \hat{v}ₙ. This adjustment ensures that the inclination of each rectangle aligns the width of the plane with the surface of the reconstructed mandible, thereby maintaining accuracy of the plate structure according to the reconstructed part of the mandible.

To maintain the integrity of the reconstructed mandibular segment, it is crucial to secure the surgical plate in its designated position. This fixation is achieved through the use of screw fasteners that connect the plate to the reconstructed mandible. The surgical plate features multiple through holes, which facilitate the attachment of the plate to the mandible with the aid of screw fasteners. The precise placement of these fasteners and their corresponding holes is determined by the surgeon after careful analysis of the patient's unique mandibular anatomy. Furthermore, it is essential to include holes at each end of the plate to prevent any potential deflection or instability at these terminal points.

The holes are positioned at the center of the plate, with the sweep path serving as the plate's central line. Consequently, it is essential to identify the hole points on curve C1. To minimize errors, the developed computer program enables users to first define the hole points before determining curve C1.

$$\begin{matrix}\begin{matrix}\begin{matrix}\begin{matrix}[ H ] = [ \begin{matrix}{h}_{1} & {h}_{2} & … & {h}_{n}\end{matrix} ] \\ H ⊆ \overline{C 1}\end{matrix} \\ where\end{matrix} \\ {h}_{1} and {h}_{n} = holes at the ends\end{matrix} \\ {h}_{2} to {h}_{n - 1} = Manually defied holes\end{matrix} \qquad ( 12 )$$

Screw holes in the plate create a thin margin, which may result in stress concentration and ultimately lead to plate fractures. To mitigate this issue, it is necessary to add additional material around the screw holes, thereby increasing the hole margin and effectively managing the stress distribution throughout the plate.

To expand the plate's width around the screw holes, the rectangles close to the holes are stretched along the z-axis (refer to FIG. 5A), and their height is increased proportionally to the distance between the rectangle's centre point and the nearest hole's center, as illustrated in Equation 14. This distance is represented by D, signifying the diameter of the circular structure surrounding the hole with diameter d.

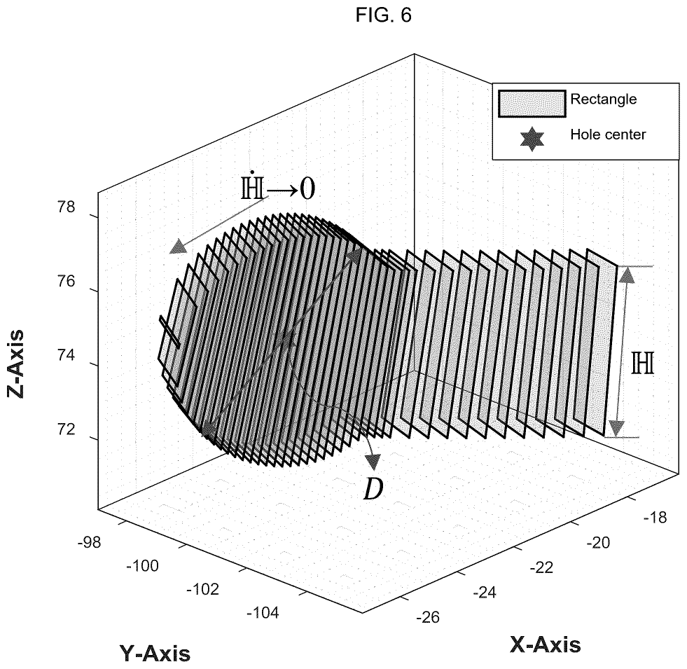

Moreover, at the ends of the plate, the height of the rectangle continuously decreases, ultimately forming a circular disk-shaped structure as illustrated in the FIG. 6. In other words, it can be stated that the height of the rectangle adheres to the equation of a circle.

$${ℍ}_{n} = \{ \begin{matrix}ℍ , & k > D / 2 \\ \dot{ℍ} , & k \leq D / 2\end{matrix} \qquad ( 13 )$$

$$\dot{ℍ} = \frac{D}{2} sin \{ {cos}^{- 1} ( \frac{k}{D / 2} ) \} \qquad ( 14 )$$

$$\begin{matrix}\begin{matrix}where , \\ k = distance of {c}_{n} from the centre of the nearest hole\end{matrix} \\ ℍ = half of the plate width\end{matrix}$$

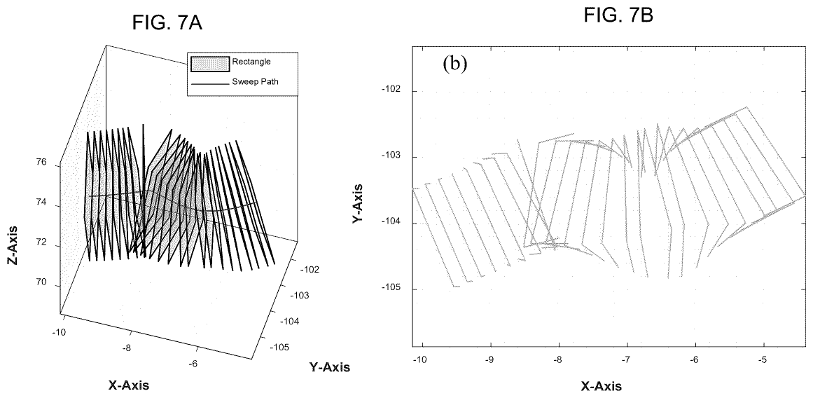

After implementing the cubic spline smoothing of the sweep path, the plate smoothness can be assured. But in the case of complimented geometry, the chances of intersection between a few rectangles (FIGS. 7A and 7B) that are placed along the sweep path cannot be neglected. The intersection of rectangles will cause errors in the surface model that result in the inappropriate design of the plate. To avoid such error the intersection between rectangles is detected. However, it is very rare to have such rectangles, so such rectangles are removed from the sweep geometry.

The intersection detection algorithm efficiently identifies the intersection between two 3D rectangular regions

$$( {G}_{n}^{′} , {G}_{( n + 1 )}^{′} ) .$$

The primary input to this function consists of two 4×3 matrices, each representing a 3D rectangle through the (x, y, z) coordinates of its four corners represented by equations 15 and 16. The algorithm initiates the process by calculating the edges \vec{E}ₙ and \vec{E}₍ₙ₊₁₎ of both input rectangles as shown equations 17 and 18.

$$[ {G}_{n}^{′} ] = [ \begin{matrix}{g}_{{n}_{11}}^{′} & {g}_{{n}_{12}}^{′} & {g}_{{n}_{13}}^{′} \\ {g}_{{n}_{21}}^{′} & {g}_{{n}_{22}}^{′} & {g}_{{n}_{23}}^{′} \\ {g}_{{n}_{31}}^{′} & {g}_{{n}_{32}}^{′} & {g}_{{n}_{33}}^{′} \\ {g}_{{n}_{41}}^{′} & {g}_{{n}_{42}}^{′} & {g}_{{n}_{43}}^{′}\end{matrix} ] \qquad ( 15 )$$

$$[ {G}_{( n + 1 )}^{′} ] = [ \begin{matrix}{g}_{{( n + 1 )}_{11}}^{′} & {g}_{{( n + 1 )}_{12}}^{′} & {g}_{{( n + 1 )}_{13}}^{′} \\ {g}_{{( n + 1 )}_{21}}^{′} & {g}_{{( n + 1 )}_{22}}^{′} & {g}_{{( n + 1 )}_{23}}^{′} \\ {g}_{{( n + 1 )}_{31}}^{′} & {g}_{{( n + 1 )}_{32}}^{′} & {g}_{{( n + 1 )}_{33}}^{′} \\ {g}_{{( n + 1 )}_{41}}^{′} & {g}_{{( n + 1 )}_{42}}^{′} & {g}_{{( n + 1 )}_{43}}^{′}\end{matrix} ] \qquad ( 16 )$$

$${\vec{E}}_{n} = \{ {row}_{i} [ {G}_{n}^{′} ] - {row}_{j} [ {G}_{n}^{′} ] \vert i , j ∈ \{ 1 , 2 , 3 , 4 \} , i \neq j \} \qquad ( 17 )$$

$${\vec{E}}_{( n + 1 )} = \{ {row}_{i} [ {G}_{( n + 1 )}^{′} ] - {row}_{j} [ {G}_{( n + 1 )}^{′} ] \vert i , j ∈ \{ 1 , 2 , 3 , 4 \} , i \neq j \qquad ( 18 )$$

Subsequently, the algorithm computes the normal vectors of all potential separating planes between the rectangles using the cross-product of their respective edges. To ensure the accuracy of further calculations, these normal vectors are normalized.

For each pair of edges, one from

$$[ {G}_{n}^{′} ]$$

and one from

$$[ {G}_{( n + 1 )}^{′} ] ,$$

the cross-product is calculated to obtain the normal vector \vec{Ψ} of the potential separating plane:

$$\vec{Ψ} = \{ {\vec{E}}_{{n}_{i}} \times {\vec{E}}_{{( n + 1 )}_{j}} \vert i , j ∈ \{ 1 , 2 , 3 , 4 \} \} \qquad ( 19 )$$

Each normal vector is divided by its magnitude to obtain a unit vector:

$$\hat{Ψ} = \{ \frac{{ψ}_{i}}{‖ {ψ}_{i} ‖} \vert {ψ}_{i} ∈ \vec{Ψ} \} \qquad ( 20 )$$

The core of the function involves checking for overlaps across all potential separating planes. To accomplish this, the algorithm projects the corners of both rectangles onto the current separating plane and subsequently verifies the presence of overlap along that specific plane. If an overlap is detected, the function proceeds to examine the next plane. However, if a non-overlapping separating plane is identified, the function returns a Boolean variable ‘isIntersecting’ as false, along with an empty ‘intersectionBox’.

For each normalized normal vector \hat{ψ} the corners of both rectangles

$${G}_{n}^{′} and {G}_{( n + 1 )}^{′}$$

are projected onto the separating plane defined by \hat{ψ}%:

$${P}_{n} = \{ \hat{ψ} \cdot {row}_{i} [ {G}_{n}^{′} ] \vert i ∈ \{ 1 , 2 , 3 , 4 \} \} \qquad ( 21 )$$

$${P}_{( n + 1 )} = \{ \hat{ψ} \cdot {row}_{i} [ {G}_{( n + 1 )}^{′} ] \vert i ∈ \{ 1 , 2 , 3 , 4 \} \} \qquad ( 22 )$$

When the function completes the loop without finding a separating plane, it determines that the rectangles intersect. In this case, the function returns “as true.” The “isIntersecting” variable acts as an identifier for each rectangle, aiding in the exclusion of intersecting areas during surface model generation. The rectangle that shows intersections with the maximum number of other rectangles is excluded, and the algorithm rechecks the remaining rectangles for intersection. This loop is carried out until all intersections are removed. This function provides a reliable and efficient method for detecting intersections between 3D rectangular regions, making it a valuable tool for various applications such as computer graphics, physics simulations and computational geometry.

$$𝔾 = \{ \begin{matrix}= {G}_{n}^{′} , isIntersecting = False \\ \neq {G}_{n}^{′} , isIntersecting = True\end{matrix} \vert i ∈ \{ 1 , 2 , 3 , ... , n \} \} \qquad ( 23 )$$

After removing intersecting rectangles, the point cloud is further processed to generate a surface model of the plate. The resulting surface model does not have any holes. To create holes, a Boolean operation is performed, and a cylindrical surface model of the hole is subtracted from the plate.

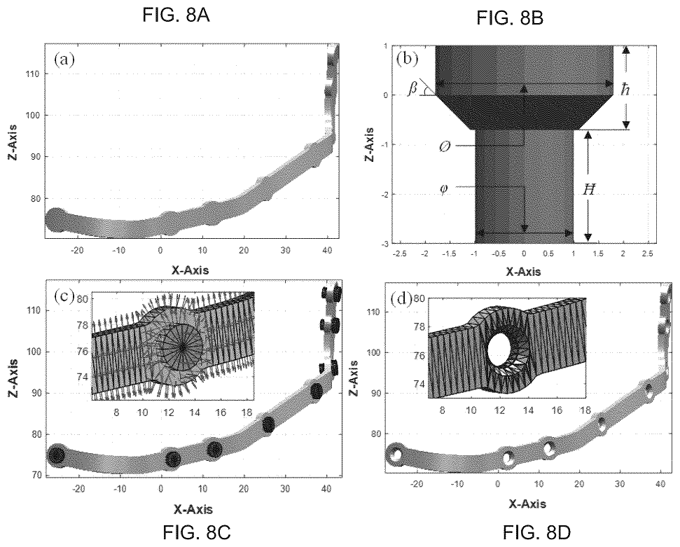

The surface model of the hole is constructed by defining circles along the z-axis at varying heights and connecting the peripheral points of these circles to form the surface model, as illustrated in FIGS. 8A-8D. A computer program has been developed to generate a 3D surface model of the hole based on specified parameters, such as diameter (φ), head diameter (Ø), height (H), head height (ℏ), and head angle (β) as shown in FIG. 8B. This model is represented as a mesh comprised of vertices and faces. The program employs mathematical functions and geometric operations to create the mesh, visualize the hole and save the model as an ASCII STL file.

Initially, the diameters and heights for various parts of the hole are defined using the input parameters. Then, the center points of different circles are calculated along the Z-axis based on the height, head height, and head angle. Subsequently, a set of points on the periphery of each circle is computed using the parametric equation of a circle, determining the X, Y, and Z coordinates for each point.

The program creates the vertices and faces of the hole mesh by iterating through the circle points and triangulating them using geometric operations. This process establishes connectivity between adjacent circles, forming the surface of the hole. Furthermore, the ends of the hole are closed by connecting the first and last circles to their respective centre points using additional faces. The resulting mesh is employed to subtract from the surface model of the plate in order to create the holes.

The surface model of the hole is translated and positioned at the appropriate location prior to the Boolean operation, as illustrated in FIG. 8C. The surface model of the hole is aligned with the hole vector, which is the direction vector of the hole's polar axis. Before executing the Boolean operation, it is necessary to examine the surface models for errors related to facet orientation. The zoomed-in insert of FIG. 8C reveals that the normal of each facet points in the outward direction, indicating that an error-free STL model of the plate will be generated after the Boolean operation.

To perform a Boolean subtraction operation between a surface model of the plate and the hole, a modified version of the computer program developed by Eric Trudel (2023) [13] is employed, with some changes made to the core functionality. The code effectively handles surface Boolean operations for triangular mesh representations of the 3D shapes.

Initially, the input meshes undergo visualization and pre-processing to ascertain their quality and water tightness. The algorithm then proceeds to compute the intersection curves between the two shapes, subsequently forming intersection loops. This is followed by the creation of sub-surfaces, during which the code identifies the specific Boolean operations associated with each sub-surface, such as union, subtraction or intersection. For the presented algorithm the code is modified to save the STL file of the plate which is generated by the subtraction.

The code generates the desired resulting shape of the plate as shown in FIG. 8D, which is the subtraction of the surface model of the hole of FIG. 8B from the surface model of the plate FIG. 8A. This outcome is then exported as an ASCII STL file, paving the way for further analysis or application. This approach ensures an efficient and accurate implementation of Boolean operations on 3D shapes, allowing for the creation of complex geometries.

After creating the CAD model of the PSI, its STL model is virtually assembled with the reconstructed part to verify its functionality and accuracy. This is followed by Finite element analysis to ensure the structural strength of the plate and fabrication using additive manufacturing.

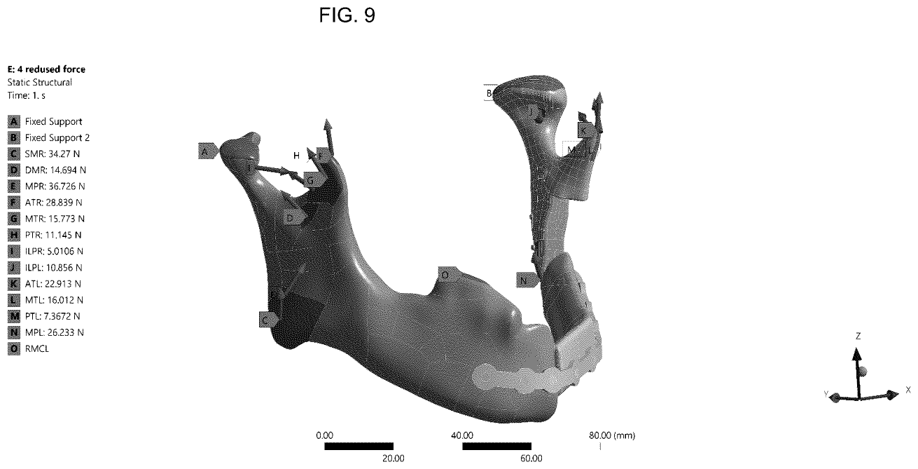

The structural strength of plates used in clenching tasks is analysed by simulating them within a finite element analysis environment. FIG. 9. The boundary conditions for these simulations are determined based on a review of relevant literature, with modifications made to suit the specific case. To closely represent clenching of the jaw under post-operative conditions, muscle forces are scaled in relation to the calculated tooth reaction force (occlusal force) and the pre-operative measured occlusal force. By scaling force magnitudes according to the patient's preoperative occlusal force, the post-operative conditions can be simulated while accounting for the expected significant decline in bite force [10, 14]. This approach allows for the establishment of a reasonable margin for estimating the potential structural failure of the plate, which serves as a factor of safety.

With this invention a mechanistic model is used to calculate tooth reactions based on muscle force vectors. According to the first principle of mechanics, the sum of all forces applied to the mandible and the sum of moments caused by these forces will be zero. In other words, the reaction force will balance the force applied by muscles during clenching. The reaction force at the point of resistance (both condyle and teeth) was calculated. Each of these resistance vectors contained x, y, and z components, similar to the force vectors. Consequently, a total of nine unknowns needed to be determined from six equations. Solving these six equations with nine unknowns was not possible. However, by considering some reasonable assumptions, as described by Nelson (1986), these equations could be solved.

$$\sum {F}_{x} = 0 \qquad ( 24 )$$

$$\sum {F}_{y} = 0 \qquad ( 25 )$$

$$\sum {F}_{z} = 0 \qquad ( 26 )$$

$$\sum {M}_{x} = 0 \qquad ( 27 )$$

$$\sum {M}_{y} = 0 \qquad ( 28 )$$

$$\sum {M}_{y} = 0 \qquad ( 29 )$$

where:
Fₓ, F_{y}, and F_{z} are the force vector components in the x, y, and z directions, respectively.
Mₓ, M_{y}, and M_{z} are the moments of various forces along in the x, y, and z directions, respectively.

The orientation of the tooth resultant vector is assumed in terms of α (lateral) and β (frontal) angle. Additionally, it is assumed that the reaction vector of the left condyle is forming the γ angle with the x-axis. The assumption can be written as:

$$tan ( α ) = \frac{Tz}{Ty} \qquad ( 30 )$$

$$tan ( β ) = \frac{Tz}{Tx} \qquad ( 31 )$$

$$tan ( γ ) = \frac{CLz}{CLx} \qquad ( 32 )$$

where:
Tₓ, T_{y}, and T_{z} are the tooth reaction components in the x, y, and z directions respectively
CLₓ and CL_{z} are reaction forces at the left condyle along the x and z axes.

By solving the equations (24-32) for the muscle force values listed in Table 1, and assuming values of α, β and γ are 100°, 70° and 90° respectively, three reaction vectors are calculated: one at the tooth and two at the condyles. The muscle forces are then scaled according to the tooth reaction force (T) obtained from the calculation and cleaning force 91N measured at the right molar before the patient's surgery. These scaled muscle force values are used to simulate the clenching task using finite element analysis.

TABLE 1
Muscle force value is used to solve the mechanistic model.

| Side | Muscle Name | X (N) | Y (N) | Z (N) |
|---|---|---|---|---|
| Right | Superficial Masseter (SMR) | −28.38 | 57.44 | 121.19 |
| | Deep Masseter (DMR) | −32.08 | −21.03 | 44.53 |
| | Medial Pterygoid (MPR) | 71.36 | 54.77 | 116.14 |
| | Anterior Temporalis (ATR) | −17.19 | 5.07 | 113.96 |
| | Middle Temporalis (MTR) | −14.01 | −31.55 | 52.81 |
| | Posterior Temporalis (PTR) | −9.28 | −38.14 | 21.14 |
| | Inferior Lateral Pterygoid (ILPR) | 12.63 | 15.17 | −3.49 |
| Left | Medial Pterygoid (MPL) | −50.97 | 39.12 | 82.96 |
| | Anterior Temporalis (ATL) | 13.65 | 4.03 | 90.54 |
| | Middle Temporalis (MTL) | 14.22 | −32.03 | 53.61 |
| | Posterior Temporalis (PTL) | 6.13 | −25.21 | 13.98 |
| | Inferior Lateral Pterygoid (ILPL) | −27.35 | 32.87 | −7.56 |

Finite Element Analysis (FEA) using ANSYS workbench is conducted to evaluate and confirm the strength and functionality of the PSI designed with the proposed method. The hypothesis asserts that the plate should be able to bear the force that comes during right molar clenching.

The STL model of the reconstructed part undergoes processing in 3Matic to remove spikes and regenerate the triangular mesh of the STL file with uniform density. The uniform triangulation helps to calculate the watertight surface model of the part, which can be converted into a solid model used in FEA. The developed PSI is assembled with the reconstructed model and imported into the ANSYS workbench, followed by meshing. A ten-nodded tetrahedral mesh is utilized, with varying mesh sizes for different parts of the assembly. Further mesh convergence analysis is performed to ensure the precise mesh density of the model.

For computational work simplification, the mesh model of assembly is assumed to be homogeneous, isotropic and linearly elastic. The PSI and screw were assigned the material properties of Titanium alloy (Ti-6AL-7Nb) having a Young's modulus of 105 GPa and a Poisson's ratio 0.36 [15]. The reconstructed mandible was modelled to be a dense cortical bone having a Young's modulus of 13700 MPa and a Poisson's ratio of 0.3 based on considerations as indicated by Qimin et al (2021) [16].

The assembly is composed of different parts that include a restationed mandible, a reconstructed fibula free flap part, PSI, and screws to fix the physical assembly. In multibody FEA simulation, it is deemed necessary to define the contact between different mating parts. So that the appropriate mathematical condition can be imposed in computational models that mimic the real-world contact of respective bodies. In the presented invention the frictional contact was employed at the interface of the screw with bone and PSI. The coefficient of friction between the screw and bone is defined as 0.3, while for the screw and plate interface it is defined as a ‘bonded’ interface [16]. The interface between plate and bone is defined as a frictionless bond which only provides normal reaction and restricts the virtual model of the PSI and bone from intersecting each other.

Muscle forces to simulate right molar clenching are listed in Table 2. The force is in accordance with the literature [17-20]. Since the left superficial masseter and deep masseter were detached during the surgery these force vectors are not considered for this simulation. For right molar clenching the condyles is fixed along x, y, and z directions and the right molar is supported as a frictionless support that restricts the movement of the molar in z+ direction [17].

The results can be divided into three parts: 1) Output of the developed algorithm, which delivers a CAD model of the PSI; 2) Reaction force calculated from the mechanistic model; and 3) Results of the finite element analysis.

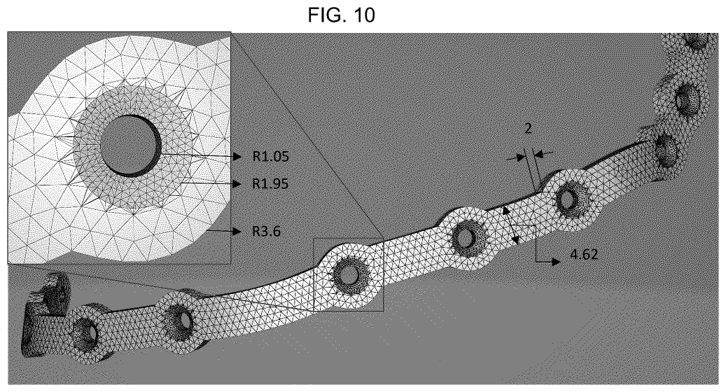

1) Output of the developed algorithm: The proposed algorithm demonstrates a substantial enhancement in efficiency and speed compared to traditional CAD model design methods. Defining the curves takes approximately 1 minute while processing the data and generating the CAD model requires an additional 40-60 seconds. This represents a significant improvement over the conventional methods, which typically take 1-2 hours. The generated STL model exhibits high quality, i.e. it is devoid of errors such as holes, missing facets, or overlapping facets. FIG. 10 illustrates the error-free STL model.

This innovative approach to CAD modelling has the potential to conserve time and resources while ensuring high-quality results. A statistical analysis of the triangles reveals that the model consists of 19,116 triangles. The minimum triangle size is 6.9559e-09 mm, the maximum triangle size is 0.44 mm, and the average triangle size is 0.11 mm.

2) Reaction force calculated from the mechanistic model: After solving the mechanistic model for muscle forces as described in Table 1, the calculated tooth reaction vector resultant is found to be 365.13 N. The reactions at the left and right condyles are 125.02 N and 336.47 N, respectively. The ratio of total joint or condylar force to total tooth reaction force is 1.26. It is assumed that the forces of resistance occurring at the joints are a residual effect of the production of useful force at the teeth and the former arise only as a stabilizing influence on the system. The ratio between these forces would therefore reflect some element of the efficiency of the system concerning the distribution of these forces. The scaled muscle forces, based on the calculated tooth reaction and bite force, are presented in Table 2.

TABLE 2
Scaled muscle force value used to simulate right molar clenching.

| Side | Muscle Name | X (N) | Y (N) | Z (N) |
|---|---|---|---|---|
| Right | Superficial Masseter (SMR) | −7.09 | 14.36 | 30.30 |
| | Deep Masseter (DMR) | −8.02 | −5.26 | 11.13 |
| | Medial Pterygoid (MPR) | 17.84 | 13.69 | 29.04 |
| | Anterior Temporalis (ATR) | −4.30 | 1.27 | 28.49 |
| | Middle Temporalis (MTR) | −3.50 | −7.89 | 13.20 |
| | Posterior Temporalis (PTR) | −2.32 | −9.53 | 5.29 |
| | Inferior Lateral Pterygoid (ILPR) | 3.16 | 3.79 | −0.87 |
| Left | Medial Pterygoid (MPL) | −12.74 | 9.78 | 20.74 |
| | Anterior Temporalis (ATL) | 3.41 | 1.01 | 22.64 |
| | Middle Temporalis (MTL) | 3.55 | −8.01 | 13.40 |
| | Posterior Temporalis (PTL) | 1.53 | −6.30 | 3.49 |
| | Inferior Lateral Pterygoid (ILPL) | −6.84 | 8.22 | −1.89 |

From FIG. 9 and the reaction data of right and left forces, it can be asserted that the right-side muscles apply more force than the left side.

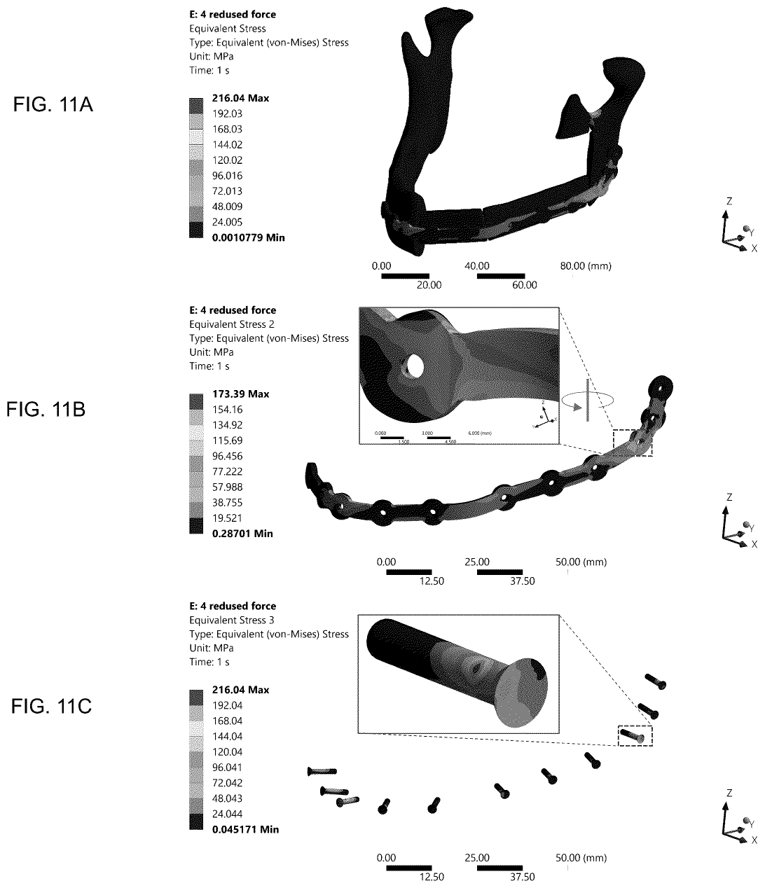

3) Results of the finite element analysis: The maximum stress in the plate is 173.39 MPa while the 9^{th} screw located near the junction point of the reconstructed and reactions part of the mandible shows maximum von Mises stress of 216.04 MPa which is less than the ultimate yield strength of titanium alloy i.e. >800 MPa [21]. But these stress levels are at the boundary of yield strength of pure titanium grade-I i.e. 170 MPa [22]. The stress and strain distribution are presented in FIGS. 11A-C and 12A-C, respectively.

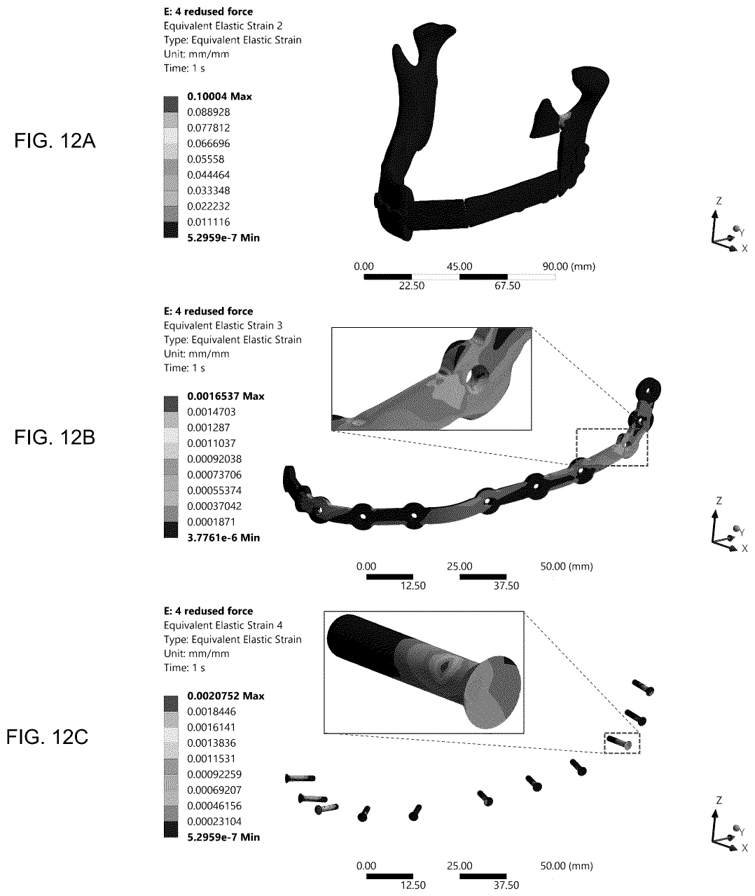

The strain distribution in the mandibular notch displays a value of 0.1, which can be attributed to the structural changes in the mandible, rather than having any significant impact on the plate. As indicated in the enlarged insert of FIG. 12B, the plate exhibits an elastic strain of 0.001. Concurrently, the screw situated at this location experiences the maximum strain of 0.002, resulting from the junction between the left part of the mandible and the reconstructed bone as indicated in the enlarged insert of FIG. 12C. This screw plays a pivotal role in load transfer between the plate and the mandible.

The advanced algorithm developed for CAD modelling of maxillofacial implants automatically generates the CAD model based on defined design parameters, such as the dimensions of the plate and the smoothness factor. This algorithm-driven approach allows for a more efficient and flexible design process compared to conventional methods, which involve time-consuming manual CAD modelling and editing of STL files. Although the specific design steps for the plate are not detailed in the literature, it is typically created by manipulating the bone's STL file or primitive geometries through Boolean operations. This is time-consuming and requires specific engineering skills, making it difficult for surgeons to perform.

Another common issue with STL manipulation is the potential for errors that must be addressed before 3D printing. However, the developed algorithm overcomes this problem by generating error-free STL files with adaptive meshing, ensuring accurate details and avoiding volumetric errors related to CAD modelling. In contrast to conventional methods, the presented algorithm does not require specialized knowledge of CAD modelling to design patient-specific implants, making it a more accessible and efficient solution.

The sweep-based surface modelling approach creates a smooth CAD model for the implant plate, effectively eliminating sharp edges or vertices that could cause stress concentration. The Finite Element Analysis (FEA) demonstrates that the designed plate can withstand forces under simulated conditions for right molar clenching. However, it is essential to consider the variability in clenching forces among individuals, as using the same forces from the literature may not be suitable for everyone. Furthermore, post-surgery conditions may vary; some muscles could be detached from the mandible during surgery and not participate in bite actions, thus not applying forces. Such post-operative conditions should also be addressed.

To tackle this issue, the patient's bite force at the right molar was measured. A tooth reaction force at the right molar was calculated using a mechanistic model based on muscle force values from the literature [18, 19]. This calculation estimates the patient's bite force when subjected to the given muscle force value. The muscle force value was then adjusted according to the patient's bite force, resulting in a reduced reaction force within the appropriate bite force range of the patient.

By applying the adjusted force value as the boundary condition for the FEA analysis, a more accurate and personalized representation of the patient's bite force is achieved. This ensures that the implant plate design is better suited to the individual's needs, taking into account both pre-existing conditions and potential post-operative changes. It is obvious that there are always certain changes in bite force after the surgery due to loss of muscle and other causes and it is significantly reduced.

The yield strength of 3D printed titanium alloy Ti-6Al-7Nb can vary depending on the specific additive manufacturing process used, such as Selective Laser Melting (SLM) or Electron Beam Melting (EBM), as well as the processing parameters and post-processing treatments. Generally, the yield strength of 3D-printed Ti-6Al-7Nb falls within the range of 800-1100 MPa. If the plate is fabricated using Ti-6Al-7Nb, the designed plate will operate with a factor of safety of 4.5. On the other hand, if the plate is considered for fabrication using titanium grade 1, it may exhibit some yielding at the given force value. However, in practical scenarios, there is usually a reduction in bite force after surgery, which provides some margin for the plate's yielding until the joint's healing of the bone segments occurs and becomes the main weight-bearing structure.

The highest stress is observed near the 9th screw location on the plate and within the same screw, indicating that the majority of the load is being transferred to the plate by the screw. Variations in cross-section and geometric curvature affect the stress flow, resulting in increased stress concentration at the neck area of the bolt island and the plate, as shown in FIG. 11C. Although the plate design could be enhanced to manage this stress, it is not reaching the ultimate yield point, so it can be considered a safe design.

The developed algorithm for plate design has been tested across several cases. When utilizing this algorithm, it is essential to define specific parameters that influence the plate's smoothness and structure, such as the allowable error in the cubic smoothing spline, as well as the thickness and width of the plate. The curve's smoothness involves the moving average of the points. As such, it is recommended that the curves be defined before the holes, ensuring that the holes remain in their designated positions. The algorithm autonomously determines the location of the plate's endpoints, eliminating the need to manually define the first and last hole. This feature streamlines the design process and contributes to the overall efficiency and accuracy of the plate design algorithm.

The current algorithm has some limitations in modelling the complex reconstruction plate. The presented algorithm addresses the design of PSI only for single-barrel reconstruction. Enhancement of the algorithm for multilateral cases is possible. After designing the plate needs to be inspected for its functioning and geometry. As design and modelling are based on the input parameter, sometimes the design must be fine-tuned to get the perfect design for any specific case. However, in general, the algorithm generates the most suitable model for any given case of reconstruction.

When creating models that involve complex interactions in biology, managing and controlling many variables is necessary. While an ideal model should encompass all relevant factors, certain assumptions are needed to determine the most crucial variables and how to incorporate them. One of these models is the presented mechanistic model, which assumes that there will be no relative movement between the different parts of the reconstructed mandala. To simplify force variables, calculating resistance force distributions requires designating the left condyle frontal angle of resistance. In static analysis, tooth and joint contact positions for resistance forces are assumed to be single points instead of surfaces or multiple points.

One of the limitations of the FEA model of this invention is that it only analyses the right molar clenching task. This is due to the anatomy of the reconstructed mandible, which allows only the simulation of right molar clenching because of the absence of left molar teeth and detached masseter muscles on the left side of the mandible. However, with a safety factor greater than 4 for titanium alloy, it can be concluded that the plate will function without yielding or fracturing. Furthermore, the plate's width can be increased to better manage stress concentration.

The novel algorithm of the present invention has the potential to significantly transform the field of patient-specific implant design by streamlining the traditionally complex and time-consuming CAD process. It enables surgeons to design their patient-specific implants in an easy, efficient and reliable manner. The algorithm can be popularized for use among clinicians to reduce the burden of preoperative virtual surgical planning (“VSP”). This innovative approach is also another step towards AI-assisted VSP that utilizes computational capabilities to design the perfect plate automatically.

The unique elements of the invention include: (1) an innovative algorithm that streamlines the CAD process for patient-specific implants, making it more efficient and user-friendly, by automating several design steps, reducing the dependency on advanced engineering skills and making the process more accessible to surgeons; and (2) stress concentration management, which involves the algorithm's unique ability to adjust the shape of the implant to manage stress concentration, ensuring the longevity and durability of the implant.

These novel and unobvious elements contribute to the improvement of the existing process of designing patient-specific implants for jaw resection and reconstruction, offering a more efficient, accessible, and durable solution compared to existing methods in the field of computer-assisted surgery.

The advantages of this invention over existing methods include:
1. Automation: The algorithm automates several design steps, reducing the dependency on advanced engineering skills and making the process more accessible to surgeons.
2. Timesaving: The new method significantly reduces the time spent on designing patient-specific implants, allowing for rapid alterations to the design in a matter of minutes.
3. Enhanced durability: The algorithm adjusts the shape of the implant to manage stress concentration, ensuring the longevity and durability of the implant.
4. Improved surgical planning and patient outcomes: By simplifying the design process and making it more efficient, the invention has the potential to improve surgical planning, leading to better patient outcomes.

Overall, this invention offers a more efficient, accessible, and durable solution for designing patient-specific implants compared to existing methods in the field of computer-assisted surgery.

The above are only specific implementations of the invention and are not intended to limit the scope of protection of the invention. Any modifications or substitutes apparent to those skilled in the art shall fall within the scope of protection of the invention. Therefore, the protected scope of the invention is to be limited only by the scope of protection of the claims.

### REFERENCES

The cited references in this application are incorporated herein by reference in their entirety and are as follows:
[1] Pu J J, Hakim S G, Melville J C, Su Y X (2022) Current Trends in the Reconstruction and Rehabilitation of Jaw following Ablative Surgery. Cancers (Basel) 14
[2] Su Y-X R, Ganry L, Ozturk C, et al (2023) Fibula Flap Reconstruction for the Mandible: Why It Is Still the Workhorse? Atlas of the Oral and Maxillofacial Surgery Clinics 31:121-127. https://doi.org/10.1016/j.cxom.2023.04.005
[3] Callahan N, Pu J J, Richard Su Y X, et al (2024) Benefits and Controversies of Midface and Maxillary Reconstruction. Atlas Oral Maxillofac Surg Clin North Am
[4] Jane Pu J, Shan Choi W, Yu P, et al (2020) Do predetermined surgical margins compromise oncological safety in computer-assisted head and neck reconstruction? https://doi.org/10.1016/j.oraloncology.2020.104914
[5] Pu J J, Lo A W I, Wong M C M, et al (2024) A quantitative comparison of bone resection margin distances in virtual surgical planning versus histopathology: a prospective study. Int J Surg 110:111-118. https://doi.org/10.1097/JS9.0000000000000780
[6] Pu J J, Choi W S, Yang W F, et al (2022) Unexpected Change of Surgical Plans and Contingency Strategies in Computer-Assisted Free Flap Jaw Reconstruction: Lessons Learned From 98 Consecutive Cases. Front Oncol 12, https://doi.org/10.3389/fonc.2022.746952
[7] Pu J J, Choi W S, Yeung W K, et al (2022) A Comparative Study on a Novel Fibula Malleolus Cap to Increase the Accuracy of Oncologic Jaw Reconstruction. Front Oncol 11. https://doi.org/10.3389/fonc.2021.743389
[8] Steffen C, Sellenschloh K, Willsch M, et al (2023) Patient-specific miniplates versus patient-specific reconstruction plate: A biomechanical comparison with 3D-printed plates in mandibular reconstruction. J Mech Behav Biomed Mater 140. https://doi.org/10.1016/j.jmbbm.2023.105742
[9] Kreutzer K, Lampert P, Doll C, et al (2023) Patient-specific 3D-printed mini-versus reconstruction plates for free flap fixation at the mandible: Retrospective study of clinical outcomes and complication rates. Journal of Cranio-Maxillofacial Surgery 51:621-628. https://doi.org/10.1016/j.jcms.2023.09.019
[10] Ruf P, Orassi V, Fischer H, et al (2024) Biomechanical evaluation of CAD/CAM magnesium miniplates as a fixation strategy for the treatment of segmental mandibular reconstruction with a fibula free flap. Comput Biol Med 168. https://doi.org/10.1016/j.compbiomed.2023.107817
[11] Memon A R, Wang E, Hu J, et al (2020) A review on computer-aided design and manufacturing of patient-specific maxillofacial implants. Expert Rev Med Devices 17:345-356
[12] Koppunur R, Dama K K, Rokkala U, et al (2022) Design and Fabrication of Patient-Specific Implant for Maxillofacial Surgery Using Additive Manufacturing. Advances in Materials Science and Engineering 2022. https://doi.org/10.1155/2022/7145732
[13] Eric Trudel (2024) Surface Booleans (https://www.mathworks.com/matlabcentral/fileexchange/122502-surface-booleans), MATLAB Central File Exchange. Retrieved Apr. 10, 2024.
[14] Zheng K, Liao Z, Yoda N, et al (2019) Investigation on masticatory muscular functionality following oral reconstruction—An inverse identification approach. J Biomech 90:1-8. https://doi.org/10.1016/j.jbiomech.2019.04.007
[15] Baltatu M S, Vizureanu P, Sandu A V, et al (2023) Research Progress of Titanium-Based Alloys for Medical Devices. Biomedicines 11. https://doi.org/10.3390/biomedicines11112997
[16] Shi Q, Sun Y, Yang S, et al (2021) Preclinical study of additive manufactured plates with shortened lengths for complete mandible reconstruction: Design, biomechanics simulation, and fixation stability assessment. Comput Biol Med 139:105008. https://doi.org/10.1016/j.compbiomed.2021.105008
[17] Huang H L, Su K C, Fuh L J, et al (2015) Biomechanical analysis of a temporomandibular joint condylar prosthesis during various clenching tasks. Journal of Cranio-Maxillofacial Surgery 43:1194-1201. https://doi.org/10.1016/j.jcms.2015.04.016
[18] Korioth T W P, Romilly D P, Hannam A G (1992) Three-dimensional finite element stress analysis of the dentate human mandible. Am J Phys Anthropol 88:69-96. https://doi.org/10.1002/ajpa.1330880107
[19] Korioth T W P, Hannam A G (1994) Deformation of the Human Mandible During Simulated Tooth Clenching. J Dent Res 73:56-66. https://doi.org/10.1177/00220345940730010801
[20] Nelson G J, Sc B, Lowe A A, et al (1986) THREE DIMENSIONAL COMPUTER MODELING OF HUMAN MANDIBULAR BIOMECHANICS
[21] Vrancken B, Thijs L, Kruth J P, Van Humbeeck J (2012) Heat treatment of Ti6Al4V produced by Selective Laser Melting: Microstructure and mechanical properties. J Alloys Compd 541:177-185. https://doi.org/10.1016/j.jallcom.2012.07.022
[22] Standard Specification for Unalloyed Titanium, for Surgical Implant Applications (UNS R50250, UNS R50400, UNS R50550, UNS R50700) 1. https://doi.org/10.1520/F0067-13R17

While the invention is explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

1. A method for forming a patient-specific implant (PSI) part for application to a resected body part to form a reconstructed part, comprising the steps of:
forming a StereoLithography (STL) model of the reconstructed part with trace lines and the location of screw holes for screws to fasten the PSI to the resected body part in forming the reconstructed part;
wherein the trace lines are processed using cubic-spline data interpolation and smoothing, followed by the generation and transformation of rectangles to create a skeleton that forms the implant's surface model;
wherein the screw holes are added to the model after the trace lines are processed;
converting the model into an STL file; and
making the STL file available for forming implant material into the PSI.

2. The method of claim 1 wherein the reconstructed part is a resected body part in the form of a mandible of a human with the PSI installed via screws inserted in the screw holes.

3. The method of claim 1 wherein fibula flap segments are used as the implant material.

4. The method of claim 2 wherein the step of making the STL file available comprises the step of importing the STL file containing the reconstructed bone into a program that processes 3D information of the mandible and represents it as a triangulated model, comprising point cloud data and a connectivity matrix;
wherein the point cloud data is represented by an n×3 matrix, where ‘n’ denotes the number of points in the point cloud and the three columns of the matrix correspond to the x, y, and z coordinates of each point in the 3D space; and
wherein the connectivity matrix has dimensions of m×3, where ‘m’ signifies the number of triangles needed to create a computer aided design (CAD) model of the mandible and the three different arrays in the matrix represent the connectivity of the points in such a way that if three points of the connectivity matrix stored in a row are joined, they form a triangle.

5. The method of claim 4 wherein, after getting the STL file of the reconstructed model, two 3-dimensional curves on the surface of the STL model of the mandible are attached, additional points are defined on the STL model that signify the location of the screws to fix the PSI with the reconstructed model and the computer program allows for visualization of the geometry of the reconstructed mandible and interactive defining of points for guide curves and the screw holes.

6. The method of claim 4 wherein the rotation of a rectangle representing a cross-sectional area of the PSI with respect to its normal ensures that the inclination of each rectangle aligns the width of the plane with the surface of the reconstructed mandible, thereby maintaining accuracy of the plate structure according to the reconstructed part of the mandible.

7. The method of claim 1 wherein rectangles that intersect are removed from the process, the step of making the STL file available comprises the step of importing the STL file into a program that processes 3D information and represents it as a triangulated model, comprising point cloud data and a connectivity matrix; and the point cloud is further processed to generate a surface model of the implant part.

8. The method of claim 1 wherein the screw holes are added by performing a Boolean operation and subtracting a cylindrical surface model of the hole from the plate.

9. A patient-specific implant (PSI) part for application to a resected mandible to form a reconstructed mandible, comprising at least on fibula flap segments formed based on:
a StereoLithography (STL) model of reconstructed mandible with trace lines and the location of screw holes for screws to fasten the PSI to the resected mandible;
wherein the trace lines are processed using cubic-spline data interpolation and smoothing, followed by the generation and transformation of rectangles to create a skeleton that forms the implant's surface model;
wherein the screw holes are added to the model after the trace lines are processed;
converting the model into an STL file; and
making the STL file available for forming the fibula flap segment into the PSI.

10. The patient-specific implant (PSI) part according to claim 8 having additional material around the screw holes so as to increase the hole margin and strengthen the plate around the hole.

11. The patient-specific implant (PSI) part according to claim 8 wherein at the ends of the plate, the height of the rectangle continuously decreases, ultimately forming a circular disk-shaped structure, i.e., the height of the rectangle adheres to the equation of a circle.
